(19) United States
(12) Patent Application Publication
(10) Pub. No.: US 2007/0276745 A1
(43) Pub. Date: Nov. 29, 2007

(54) Automated Retailing Through an Online Auction Service

(76) Inventors: Venkatesh Harinarayan, Mountain View, CA (US); Arvind Goel, Sunnyvale, CA (US); Ravi Narasimhan Raj, Los Altos, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/561,321

(22) PCT Filed: Jun. 18, 2004
(86) PCT No.: PCT/US04/19513

§ 371 Date: Mar. 27, 2007

Related U.S. Application Data
(60) Provisional application No. 60/480,520, filed on Jun. 20, 2003.

(51) Int. Cl. G06Q 40/00

(52) U.S. Cl. 705/37

(57) ABSTRACT

Computer implemented methods and apparatuses for controlling automated retailing through an online auction service are described herein.

### RELATED APPLICATIONS

This application claims the benefit of U.S. Provisional Application No. 60/480,520 filed on Jun. 20, 2003.

### FIELD OF THE INVENTION

The present invention relates to the field of computer controlled automation. More specifically, the present invention is related to methods and related apparatuses for controlling automated retailing through an online auction service.

### BACKGROUND OF THE INVENTION

Today online auction services such as eBay represent a global marketplace with over $20 Billion in gross merchandise sales this year alone. Thus far, much of the merchandise transacted through online auction services has been unique (non-commodity) items, such as collectibles, used items, refurbished items, and flawed items. For example, the marketplace model of eBay, and in particular the infrastructure, pricing, and user interface (UI), is built with the assumption that every item is unique, and thus deserves a separate listing. A listing may be thought of as an electronic posting for an item to be auctioned. In keeping with this marketplace model, every listing on eBay has a fixed listing duration indicating an amount of time a corresponding item will be listed in association with an active auction through which bidders may view and submit bids for the item. Listing durations are generally short (usually in the order of days) and are determined by the seller as part of the item listing process. Typically, the seller will choose a listing duration that he or she believes will be sufficient in order for the item to sell at the seller's desired sale price also referred to herein as a “target” price. The target price may be contrasted to a “reserve price” which represents the lowest price that a seller is willing or otherwise obligated to accept for an item. Often, the reserve price will be set lower than the target price.

Many sellers who use online auction services such as eBay are individuals selling used items they no longer need. However, many mom-and-pop shops that focus on sourcing unique items have also discovered the wide customer base that online auction services can provide. While eBay's model of individual listings may provide these sellers with a constructive method of selling items, most retailers who sell “non-unique” items focus more on merchandising and inventory management than on just sourcing. One characteristic of non-unique items is that a single “stock keeping unit” (SKU) is often used to represent many identical items. For example, a hypothetical book retailer, “Books, Ltd.,” may have 100 copies of a particular book all categorized under an identical SKU. This can be contrasted with a mom-and-pop shop that may have 3 used copies of the same book which may each be considered unique due to different wear-and-tear characteristics associated with each copy. Because of these unique characteristics, the mom-and-pop shop may charge different prices for each used book, while the large book retailer will likely charge an identical price for each of the copies of the books they stock.

One challenge for a retailer who wants to sell multiple identical items on online auction services is the mismatch between the retail market model (bulk selling) and the one-at-a-time marketplace model used by online auction services such as eBay. The one-at-a-time marketplace model is generally driven to maximize the margin on a single item, while the retail model strives to sell as many items as possible at a fixed margin.

Although a “Multiple Buy-it-Now” option currently exists on eBay to provide a cheap, single, long-life listing which can represent multiple items, this feature has been very ineffective. With this “Multiple Buy-it-Now” option, a single listing is used to represents hundreds or thousands of items, but the listing shows up only once in response to a search for the item. Additionally, the one listing will most likely end up at the bottom of the search results, because searches are often sorted by the remaining listing duration of the items. Thus, due to the long expiration duration assigned to such Buy-it-Now listings, many of the customers looking for that item will never see it.

Although, a seller has a number of options to more prominently display or “feature” listings in order to increase visibility and thus demand for the corresponding item, the high overhead cost typically associated with this procedure makes it impractical for most items. For example, in exchange for payment of a substantial fee, a seller may be able to feature an item on the home page of the auction service in order to increase visibility of the listing. Alternatively, in exchange for lesser fees, a seller may feature a listing on various category pages or search results offered by the service. Used effectively, however, featuring an item can drive up the sale price well in excess of the reserve price resulting in one item being sold at a high margin rather than multiple items being sold at lower margins. Unfortunately, this effective selling instrument can not be efficiently utilized by retailers desiring to sell multiple identical items, because featuring usually helps sell a unique item at a high margin rather than high volumes of identical items.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system/network view of the present invention, in accordance with one embodiment;

FIG. 2 illustrates an architectural view of one of the clients of FIG. 1, in accordance with an embodiment of the present invention;

FIG. 3 is a flow diagram illustrating presets an embodiment of the current invention using aspects of and link listing in accordance with one embodiment;

FIG. 4 graphically illustrates operation of the listing technique in accordance with another embodiment of the current invention;

FIG. 5 illustrates yet another embodiment of the listing technique of the current invention;

FIG. 6 illustrates a timing diagram of an embodiment similar to the one shown in FIG. 4;

FIG. 7 provides a timing diagram of an embodiment similar to the one shown in FIG. 5; and

FIG. 8 illustrates an embodiment of a featuring method that can be used in association with the present invention.

### DETAILED DESCRIPTION OF EMBODIMENTS OF THE INVENTION

In the description to follow, various aspects of the present invention will be described, and specific configurations will be set forth. However, the present invention may be practiced with only some or all aspects, and/or without some of these specific details. In other instances, well-known features may be omitted or simplified in order not to obscure the present invention.

Embodiments of the present invention include a novel computer implemented technique, apparatuses and related mechanisms for controlling automated retailing through an online auction service such as eBay. Embodiments of the present invention may facilitate a retailer, especially a non-unique good retailer, in automatically matching supply with demand, while at the same time operating to increase demand.

The description may be presented in terms of operations performed by a processor based device consistent with the manner commonly employed by those skilled in the art to convey the substance of their work to others skilled in the art. As is well understood by those skilled in the art, the quantities may take the form of electrical, magnetic, or optical signals capable of being stored, transferred, combined, and otherwise manipulated through mechanical, electrical and/or optical components of the processor based device.

In one embodiment, the present invention may be practiced in an automated manner, through the employment of one or more automatic data processing apparatuses, which may include application specific integrated circuits (ASIC), components, boards, apparatuses, and systems. These apparatuses may be endowed with instructions designed for programmatic execution by the apparatuses to practice all or portions of the teachings of the present invention.

Various operations will be described as multiple discrete steps in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous. Moreover, the term “item” is used throughout the application to broadly represent objects (physical or virtual) including, but not limited to physical products, land/chattels, automobiles, services, or any commodity that can be bought and sold on an online auction.

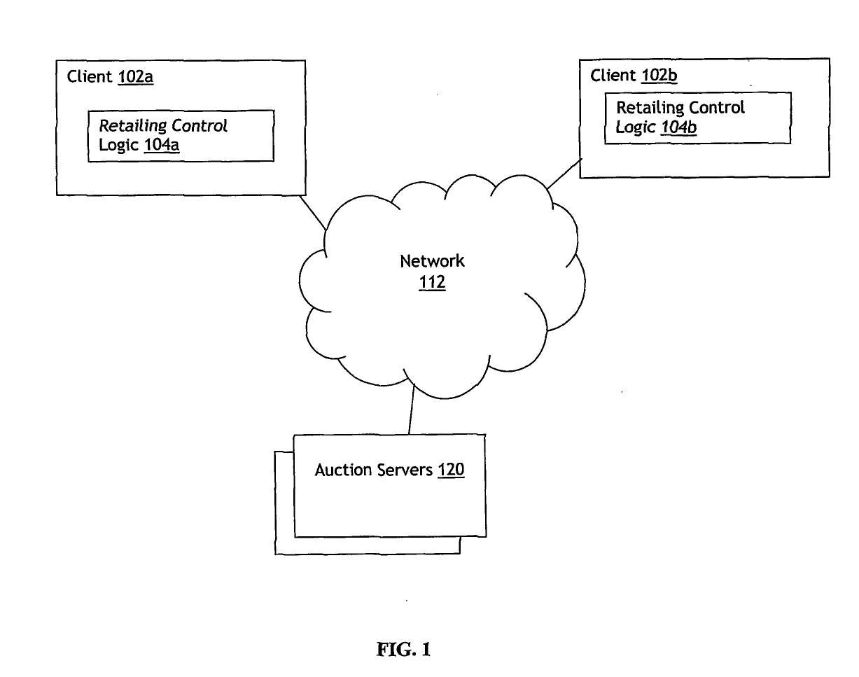

FIG. 1 illustrates a system/network view of the present invention, in accordance with one embodiment. As illustrated, clients 102a and 102b are communicatively coupled to auction server(s) 120 via network 112. One or more of clients 102a and 102b and auction servers 120 may be communicatively coupled to network 112 through one or more wired or wireless connections. Moreover, clients 102a and 102b and auction servers 120 may each represent one or more computing devices or software components designed to execute on one or more computing devices. In accordance with one embodiment of the invention, clients 102a and 102b may be provided with retailing logic 104a and 104b to facilitate bulk retailing be sellers through online auction services offered or otherwise supported by auction servers 120. Accordingly, through application of the teachings of the present invention, sellers may retail more successfully and at lower cost than through previous online retailing methods, especially with respect to non-unique goods.

Except for retailing logic 104a and 104b provided to clients 102a and 102b, the various enumerated elements of FIG. 1 represent a broad range of elements either known in the art or to be designed. For example, in one embodiment, auction servers 120 may provide auction services owned and/or operated by eBay Inc. of San Jose, Calif.

For ease of understanding, only two clients equipped with the teachings of the present invention are illustrated. However, the present invention is not limited to this illustration, and may be practiced with many clients. Further, a portion of retail logic 104a,b may be practiced on one or more client-side servers (not shown) supporting the clients and/or one or more online auction servers 120. In one embodiment, one or more online auction servers 120 may be equipped with an application programming interface (API) to facilitate automated listing submission and bid notification services incorporating one or more listing techniques described herein.

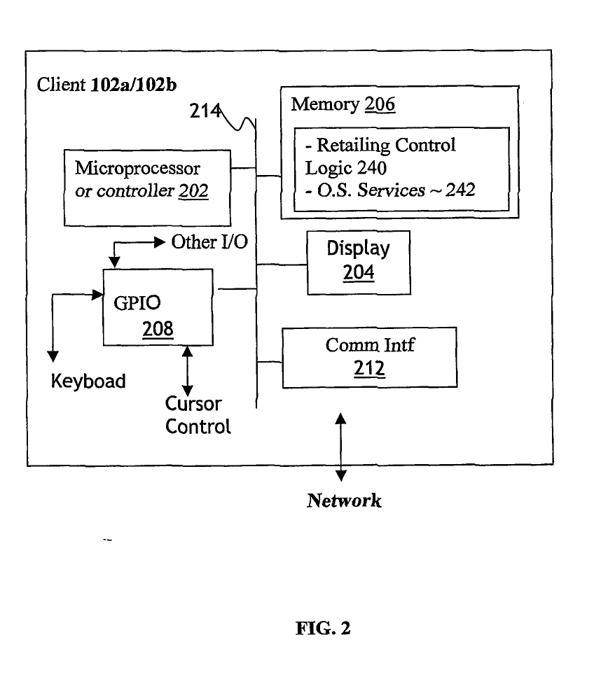

FIG. 2 illustrates an architectural view of client 102a/102b in accordance with one embodiment. As illustrated, client 102a/102b may include microprocessor/controller 202, display 204, memory 206, general purpose input/output (GPIO) 208, and network interface 212 coupled to each other via one or more buses 214, as shown.

Memory 206 may include the retailing logic 240 of the present invention to practice a number of novel listing and related techniques, and operating system services 242. Memory 206 may also be used to store various operational data, whether user-provided or client/server generated.

Retailing logic 240 may be implemented in any one of a number of programming languages known or to be designed. Typically, they are languages that may be compiled into instructions supported by the processor(s) of the host computing device.

In various embodiments, clients 102a/102b may be a desktop computer, a notebook computer, a tablet computing device, a palm sized personal digital assistant, a wireless mobile phone, or other computing devices of the like.

In alternate embodiments, all or portion of retailing logic 240 may be implemented in ASICs, embedded in electronic components, and/or circuit boards.

### Demand Listings

As described above, a listing may be thought of as an electronic posting for an item to be auctioned. The term “listing” may also be used in its verb form to represent the act of presenting an auction item for sale through an online auction service. In accordance with embodiments of the present invention, listings may be manually submitted by sellers through the use of a web browser or similarly equipped application, or automatically through a programming interface or web service published or otherwise exposed to clients equipped with retailing logic 104a,b.

In one embodiment of the present invention, new auction listings are created once a demand is identified for an associated item to avoid demand for the item being overestimated. Furthermore, in one embodiment of the invention, auction items are sold at prices that do not exceed a corresponding reserve price to avoid demand being underestimated.

In accordance with teachings of the present invention, “demand listing” may be considered a technique by which listings are inserted into or changed within an online auction based on certain demand events. Examples of demand events can include, but are not limited to: a listing expiring, the reserve price on a certain listing being met, the number of bids for a given listings exceeding a certain number, the average number of bids on all the listings corresponding to a product exceeding a certain number, etc.. Similarly, a “demand action” refers to an action (whether manual or automated) that results in or otherwise associated with a demand listing. For example, a demand action could be inserting or submitting a new listing, making an existing listing featured, closing an auction, etc..

In one embodiment, once a retailer's reserve price has been met, a demand action is deemed to occur, which in turn triggers insertion of a new listing. In one embodiment, the corresponding auction is closed to bidders when the reserve price associated with a listed item is exceeded. Thus, in accordance with one embodiment, upon occurrence of a demand even such as the reserve price of an item being met, sale of the item is awarded to the successful bidder and the auction is closed. In one embodiment, a new listing may be created contemporaneously with the sale of the original item to provide increased opportunities for bidders/buyers to purchase additional items. Although variations of this technique may include successive items being listed at some point after the sale of the original or previous item, the sooner the next item is listed, the lesser the chance may be that sales will be missed. In one embodiment, this method of listing a second item coincident with the sale of the first can be further improved to increase demand by using the first item to effectively advertise the newly listed item notwithstanding the first item being sold.

### Linked Listings

Linked Listing refers to a technique by which a given listing in an online auction service, such as eBay, is associated with other listings that currently exist within the online auction service. In one embodiment, a first auction listing having an associated reserve price that has already been met, may be associated with one or more newly listed auction items to effectively advertise the new items through the original albeit closed item listing. In one embodiment a uniform resource locator (URL) or similar reference pointer may be used to associate one item with another.

### Retail Method Using Demand and Linked Listing

In accordance with embodiments of the present invention, linked listings and demand listings can be cooperatively implemented to match supply with demand while at the same operate to increase demand.

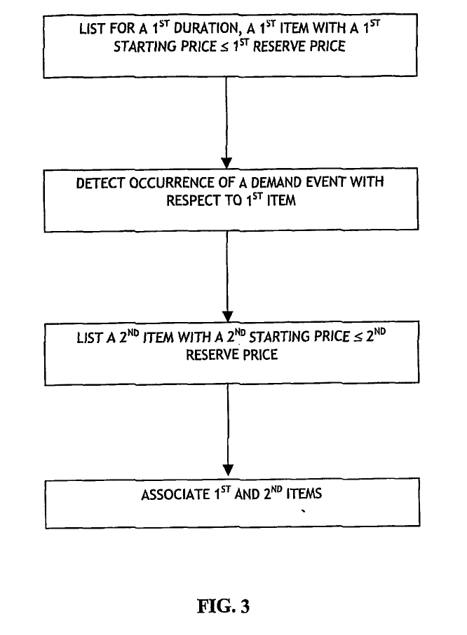

FIG. 3 is a flow diagram illustrating presets an embodiment of the current invention using aspects of and link listing in accordance with one embodiment. Referring to FIG. 3, at block 302 a first item is listed with an online auction service, such as eBay. The first item is listed for a first listing duration and with a first proposed starting price set equal to or less than a first reserve price, which in the illustrated embodiment corresponds to a target sale price. The initial item may or may not be featured on the auction site. The advantage of featuring the initial item is that it can become more visible to potential consumers, but at an additional cost. For example, eBay allows sellers to feature their products in a variety of ways, ranging from highlighting the item on a search page to publishing the item on the site's home page, as mentioned above.

At block 304 of FIG. 3, occurrence of a demand event associated with the first item is detected. In one embodiment, a demand event can be represented by a number of different events that independently or in cooperation trigger the need or demand for an additional item to be listed, as discussed above. In one embodiment, a demand event may occur when the reserve price of the initial product is reached by an online bid. However, other types of demand events, such as the item's listing duration ending, the number of bids on the item exceeding a certain number, or other various events that signify additional item demand, are possible.

At block 306, in response to the demand event being detected, a second item is listed with the online auction service. In one embodiment, the starting price set of the second item is set equal to or less than a reserve price of the second item, which in the illustrated embodiment corresponds to a target sale price for the second item.

At block 308, the second item is associated with the initial item 301. This association can include providing a hypertext link (e.g., via a URL) from the initial item to the second item or vice versa. As mentioned above, this association may provide advertising of the second item in association with the first item such as on the first item's listing page. This is notable because results of searches for particular items in online auctions are often sorted in order of corresponding listing durations. More specifically, those items having the least amount of time remaining in an auction (e.g., as indicated by the lowest listing duration) will often be listed first within a list of search results. In accordance with the illustrated embodiment of FIG. 3, because the initial item will have been listed on the online auction site longer, its remaining listing duration will be shorter and hence it will be located closer to the top of a given search result than the newly listed second item. Thus, by associating a second and subsequent items with the first listed item, even after the first item has sold, provides a method to direct potential purchasers to the lower-priced, newly listed item(s).

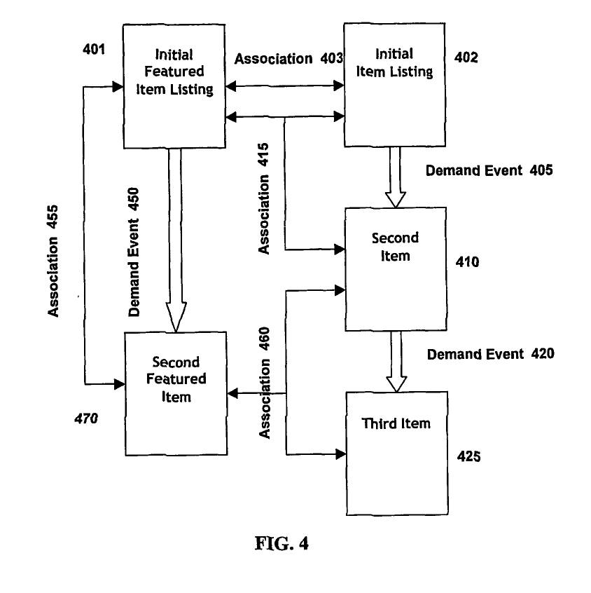

FIG. 4 graphically illustrates operation of the listing technique in accordance with another embodiment of the current invention. Referring to FIG. 4, an initial featured item 401 and initial “non-featured” item 402 are listed together, with association 403 between them. As part of the association, initial featured item 401 may refer to item 402, item 402 may refer to item 401, or each of items 401 and 402 may refer to the other. In accordance with one embodiment, initial featured item 401 may be assigned a longer listing duration than initial item 402 to maximize the value associated with featuring the item. Upon the occurrence of demand event 405 occurring to initial item 402, second item 410 may be listed. Second item 410 may then be associated with both initial featured item 401 and initial item 402 through association 415. Second featured item 470 may be listed upon demand event 450 occurring to initial featured item 401. Association 455 may then be created between initial featured item 401 and second featured item 470. Third item 425 may be listed upon the occurrence of demand event 420 to second item 410. In turn, an association between third item 425 and both second item 410 and second featured item 470 may be provided.

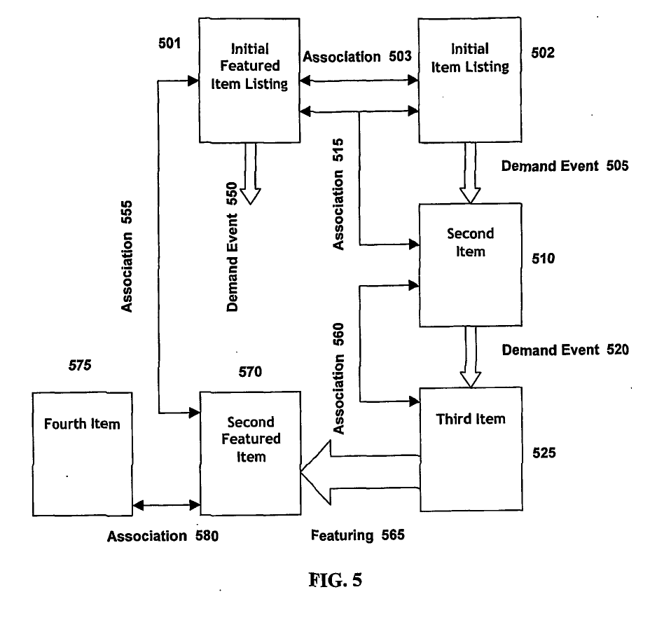

FIG. 5 illustrates yet another embodiment of the listing technique of the current invention. Referring to FIG. 5, initial featured item 501 and initial item 502 are listed together, with association 503 between them. Initial featured item 501 may have a longer listing duration than initial item 503, to harness the value of featuring the item. Again referring to FIG. 5, second product 510 may be listed when demand event 505 occurs to initial item 502. Second item 510 is than associated with both initial featured item 501 and initial item 502 through association mechanism 515. Third item 525 may be listed on the occurrence of demand event 520 to second item 510. An association between third item 525 and second item 510 may be provided for by association 560. When demand event 550 occurs to initial featured item 501, third item 525 may be featured by featuring event 565 to form second featured item 570. Coincident with featuring event 565, fourth item 575 may be listed. Association 555 is then created between initial featured item 501 and second featured item 570. In addition, association 580 is formed between fourth item 575, and second featured item 570.

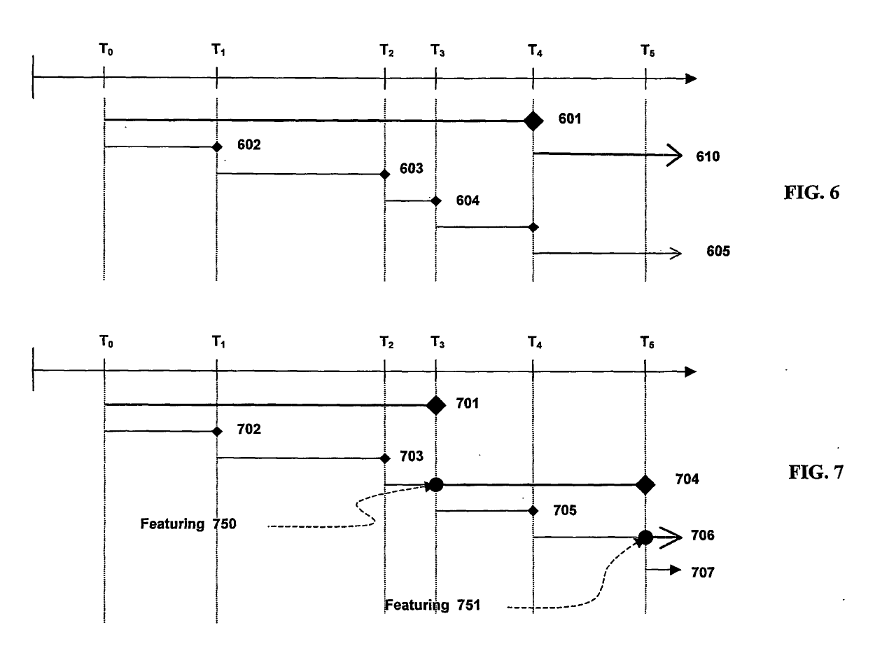

FIG. 6 illustrates a timing diagram of an embodiment similar to the one shown in FIG. 4. Referring to FIG. 6, time line 600 has times T₀, T₁, T₂, T₃, T₄, and T₅ marked. Line 601 represents a listing time of an initial featured item, while lines 602, 603, 604, and 605 represent listing times of first, second, third, and fourth listed items respectively. As can be seen from FIG. 6, this embodiment directs the featured product to have a longer listing duration than the other non-featured products. In addition, the reserve price of the featured item may be higher. Second item 603 may be listed when a demand event corresponding to first item 602 occurs. Similarly, third and fourth products, 604 and 605 respectively, are listed when a demand event corresponding to the previously listed item occurs. Second featured item, 610 may be listed when a demand event corresponding to first featured product 601 occurs.

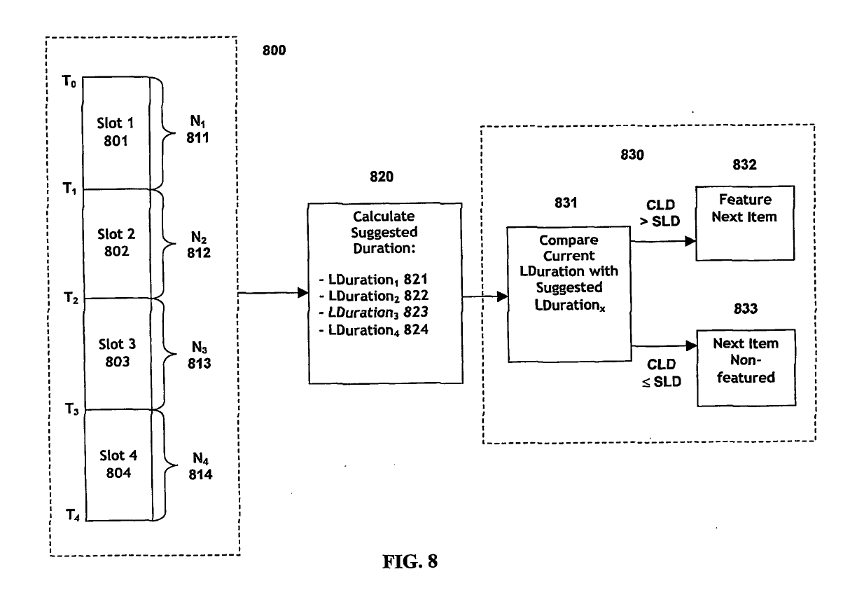

FIG. 7 provides a timing diagram of an embodiment similar to the one shown in FIG. 5. Referring to FIG. 7, time line 700 has times T₀, T₁, T₂, T₃, T₄, and T₅ marked. Line 701 represents a listing time of an initial featured item, while lines 702, 703, 704, 705, 706, and 707 represent listing times of first, second, third, fourth, fifth, and sixth listed items respectively. As can be seen from FIG. 7, this embodiment directs the initial featured item to have a longer listing duration than the other non-featured products. In addition, the reserve price of the initial featured item may be higher than the other non-featured products. Second item 703 may be listed when a demand event corresponding to first item 702 occurs. Similarly, third item 704 may be listed when a demand event corresponding to the previously listed item occurs. When a demand event occurs to first featured item 701, third item 704 may become featured through featuring event 750, and fourth item 705 may be listed.

A feature event may include any of a variety of featuring options available with the online auction site. Additionally, the type of feature used may be based off of sales history, average time before a demand event, or other factors used in determining what type of feature to use in the featuring event. For example, if actual sales figures are similar to predicted figures for an item, the item may use a less costly feature, such as bolding the item listing. In contrast, if sales numbers are less than expected for a particular item, a more ambitious feature can be utilized. The listing duration of an item may also be increased if that item becomes featured.

Referring again to FIG. 7, fifth item 706 may be listed when a demand event corresponding to fourth item 705 occurs. Finally, when a demand event corresponding to featured third item 704 occurs, fifth item 706 may become featured through feature event 751 and sixth item 707 is listed.

One of the key notion introduced in these embodiments is the existence of two classes of listings with different characteristics: featured and regular (or non-featured). Featured listings are designed to drive traffic and so it is often beneficial to keep them long-lived. Regular listings on the other hand may be short-lived or “buy-it-now” listings to facilitate a large number of sales. Given that featured listings are long-lived, and that most bids on an online auction service such as eBay happen towards the end of the auction, it may take a long time for the reserve price on the featured listing to be met.

### Featuring Listings

Another aspect of a listing on an online auction service such as eBay is the amount of user traffic it generates. However, the mere act of listing an item does not ensure that every buyer who is looking for the item will see it.

Although eBay offers sellers several ways to feature their listings and increase exposure to buyers, each feature type has additional listing fees associated with it and should therefore be used judiciously. In accordance with one embodiment of the invention, the time duration between listings in a linked listing chain may be used is an indicator of demand for the product on an online auction service and can be used as a lead indicator of when a new listing should be featured.

In accordance with one embodiment of the present invention, a listing duration for a particular item may be determined and/or specified based upon the actual time that the item is to be listed. For example, if the item is to be listed starting at midnight on a Sunday night, the listing duration specified may be slightly longer than if the item were to be listed at 10:00 in the morning on Friday with the assumption that auction traffic is heavier on Friday than it is on Sunday. This method of predicating listing duration on listing time allows items (including both featured and non-featured items) to be given a more effective listing duration. This may be particularly important with featured items because of the extra cost involved with featuring the item.

FIG. 8 illustrates an embodiment of a featuring method that can be used in association with the present invention. Referring to FIG. 8, a given selling time period 800 may be divided into an arbitrary number of time slots (e.g., Slot 1 (801), Slot 2 (802), Slot 3 (803), and Slot 4 (804). For each timeslot, the number of items that have a demand event corresponding to them occur, are counted. These numbers are represented by N₁-N₄ (811-814, respectively). After listings for an item product have reached steady state, a suggested listing duration is calculated 820 for each time slot LDuration₁-LDuration₄ (821-824, respectively). In one embodiment, when subsequent new items are to be listed during a particular time slot, the suggested listing duration corresponding to that time slot is used as the listing duration for that item. Furthermore, the manner with which an item is featured can also be determined from these suggested listing durations 830.

Referring again to FIG. 8, the duration of each listing is carefully monitored and the current listing duration (CLD) of an item may be compared to the suggested listing duration (SLD) of the particular time slot 831. In one embodiment, when the current listing duration exceeds the suggested listing duration (CLD>SLD), it signals that the next item 832 could be featured to renew visibility of the item. Likewise, when the listing duration of an item is set to the suggested listing duration and the reserve price of the item was not met by the time the listing expired, the next item 832 could similarly be featured to renew visibility of the item. Conversely, if the item's reserve price is met before the end of the suggested duration (CLD≦SLD), the next item 833 need not be featured as the demand for the item is sufficient. This procedure conserves the use of featuring, and thus cost, to times when the item needs increased visibility. In addition, the type of featuring used for an item can be determined by observing the relative difference between the current listing duration and the suggested listing duration.

For the purposes of an example, assume a selling time period (800) is defined to be a day and is divided into 4 time slots in the following manner: (Slot 1): 12 am-6 am; (Slot 2): 6 am-12 pm; (Slot 3): 12 pm-6 pm; and (Slot 4): 6 pm-12 am.

When listings for a product reach steady state, the time taken for the listing to reach a reserve bidding price (e.g., a demand event) may be recorded along with the time slot corresponding to the time the demand event occurs. Now, assume on average the number of items having demand events corresponding to them are as follows:

Slot 1: 3

Slot 2: 12

Slot 3: 18

Slot 4: 6

Thus the suggested listing duration for each item corresponding to each time slot may be determined as follows:

Slot 1: 6 Hours/3 Items=2 Hour Suggested Listing Duration

Slot 2: 6 Hours/12 Items=0.5 Hours (30 Min) Suggested Listing Duration

Slot 3: 6 Hours/18 Items=0.33 Hours (20 Min) Suggested Listing Duration

Slot 4: 6 Hours/6 Items=1 Hour Suggested Listing Duration

An item that is listed at 10:00 am would fall in Slot 2 and receive a listing duration of 30 minutes. If a demand event, such as the item's reserve price being met, occurred before the 30 minute duration expired (e.g., at 10:30 am), then an additional item could be listed with similar properties. However, if a demand event corresponding to the item did not occur before the minute duration expired, the next item to be listed could be featured to increase demand.

### Conclusion

It should be noted again that the current inventive idea is not limited to the above embodiments, but instead to the following claims.

What is claimed is:

1. A computer implemented method for controlling automated selling of multiple items through an online auction service implemented by one or more networked servers, comprising:
listing for sale with the online auction service a first item, including posting to the one or more networked servers a first reserve price corresponding to a first target sale price, a first proposed starting price set equal to or less than the first reserve price, and a first listing duration for the first item;
listing for sale with the online auction service a second item, in response to a demand event occurring within the online auction service with respect to the first item, including positing to the one or more networked servers a second reserve price corresponding to a second target sale price, and a second proposed starting price set equal to or less than the second reserve price for the second item; and
associating for the one or more networked servers, the first item with the second item.

2. The method of claim 1 further comprising featuring the first item with the online auction service, including posting a feature request with the one or more networked servers.

3. The method of claim 2 further comprising listing an additional item coincident with the first item with the online auction service, including posting to the one or more networked servers a third reserve price associated with a third target sale price, and a third proposed starting price set equal to or below the third reserve price for the additional item.

4. The method of claim 3 wherein the listing of the additional item further comprises posting to the one or more networked servers a listing duration for the additional item that is shorter that the first listing duration of the featured first item.

5. The method of claim 3 further comprising featuring a currently listed item when a demand event associated with the featured first item occurs, including posting to the one or more networked servers a feature request for the currently listed item.

6. The method of claim 3 further comprising:
identifying a listing start time for a listed item, including posting to the one or more networked servers the listing start time for the listed item ; and
determining a listing duration for the listed item based at least in part upon the identified listing start time, including posting to the one or more networked servers the listing duration for the listed item.

7. The method of claim 6 further comprising:
defining a plurality of time slots within a given period of available selling time for the listed item, including posting to the one or more networked servers definitions of the time slots;
identifying one of the plurality of time slots corresponding to the listing start time, including posting to the one or more networked servers an identification of the time slot; and
determining automatically the listing duration based at least in part upon the identified time slot, using one or more computing devices.

8. The method of claim 7 wherein a given period of available selling time is one day.

9. The method of claim 7 wherein the automatic determining the listing duration for a time slot comprises:
tracking a number of items that have had their reserve prices met during each time slot, using one or more of the computing devices; and
dividing a time length of the time slot by the number of items that have had their reserve prices met during the time slot. Using one or more of the computing devices.

10. The method of claim 7 further comprising listing a new featured item when a current listing duration of a item exceeds the determined listing duration for a corresponding time slot. Including posting a listing request to the one or more networked server.

11. The method of claim 1 wherein the method further comprising posting to the one or more networked servers the first item as an immediately purchasable item.

12. The method of claim 1 wherein the demand event occurs when a bid at least equals the first reserve price.

13. The method of claim 1 wherein the first item corresponds to a first class of items and the second item corresponds to a second class of items.

14. The method of claim 13 wherein at least one of the first class and second class of items comprises an advertising class.

15. The method of claim 13 wherein the first class of items comprises featured items and the second class of items comprises non-featured items.

16. An article of manufacture comprising:
a computer readable storage medium; and
computer executable instructions stored in the storage medium, and designed to enable a computing device to practice the computer implemented method of claim 1.

17. A computing apparatus for controlling selling of items through an online auction service, the computing apparatus comprising:
means for listing for sale with an online auction service a first item, the online auction service being implemented by one or more networked servers, the listing including posting to the one or more networked servers a first reserve price corresponding to a first target sale price, a first proposed starting price set equal to or less than the first reserve price, and a first listing duration for the first item;
means for listing for sale with the online auction service a second item, in response to a demand event occurring within the online auction service with respect to the first item, including positing to the one or more networked servers a second reserve price corresponding to a second target sale price, and a second proposed starting price set equal to or less than the second reserve price for the second item; and
means for associating for the one or more networked servers, the first item with the second item.

18. A system comprising
a communication interface;
one or more storage units to store executable instructions designed to enable the system to
list for sale with an online auction service a first item, the online auction service being implemented by one or more networked servers, the listing including posting to the one or more networked servers a first reserve price corresponding to a first target sale price, a first proposed starting price set equal to or less than the first reserve price, and a first listing duration for the first item,
list for sale with the online auction service a second item, in response to a demand event occurring within the online auction service with respect to the first item, including positing to the one or more networked servers a second reserve price corresponding to a second target sale price, and a second proposed starting price set equal to or less than the second reserve price for the second item, and
associate for the one or more networked servers, the first item with the second item; and
one or more processors coupled to the communication interface and the storage unit to execute the executable instructions.

19. The system of claim 18, wherein the instructions are further designed to enable the system to feature the first item with the online auction service, including posting a feature request with the one or more networked servers.

20. The system of claim 19, wherein the instructions are further designed to enable the system to list an additional item coincident with the first item with the online auction service, including posting to the one or more networked servers a third reserve price associated with a third target sale price, and a third proposed starting price set equal to or below the third reserve price for the additional item.

21. The system of claim 18 wherein the instructions are further designed to enable the system to post to the one or more networked servers the first item as an immediately purchasable item.

22. The system of claim 18 wherein the demand event occurs when a bid at least equals the first reserve price.
